(19) United States
(12) Patent Application Publication
(10) Pub. No.: US 2007/0283841 A1
(43) Pub. Date: Dec. 13, 2007

(54) Energy converting system

(75) Inventors: Edward Lopatinsky, San Diego, CA (US); Lev Fedoseyev, El Cajon, CA (US); Daniel Schaefer, Kanarravile, UT (US); Henry Eisenson, San Diego, CA (US)

Correspondence Address: Edward Lopatinsky, 5450 COMPLEX ST. SUITE 307, SAN DIEGO, CA, 92123, US

(73) Assignee: Industrial Design Laboratories Inc.

(21) Appl. No.: 11/804,224

(22) Filed: May 17, 2007

Related U.S. Application Data
(60) Provisional application No. 60/801,253, filed on May 18, 2006.

(51) Int. Cl. B60L 13/06

(52) U.S. Cl. 104/284

(57) ABSTRACT

An energy converting system is comprised of a track, a controller, and a magnetized body located on the track and including an energy converting unit. The track comprises electrically connected coil windings spaced apart in a series way along the track to form a 3-phase linear stator. The controller is electrically connected with the linear stator and generates a combination waveform consisting of a multi-phase propulsion signal and a power signal. The propulsion and power signals are at different frequencies. The propulsion signal causes the interaction of the magnetized body with the linear stator, thus propelling the magnetized body along the track. The energy converting unit comprises electrically connected energy consuming means and at least one pick-up coil inductively coupled to the linear stator, thus providing power to the energy consuming means.

### CROSS REFERENCE TO RELATED APPLICATIONS

The present application claims the benefit of priority of U.S. Provisional Patent Application No. 60/801,253 filed May 18, 2006 for Edward Lopatinsky et al. the entire content of which is incorporated herein by reference.

### FIELD OF THE INVENTION

The present invention relates generally to electromagnetic systems for moving mechanical bodies along predefined paths. More particularly, the present invention relates to toy and/or entertainment systems, and all subsystems in which it is useful to controllably move such a body upon such predefined paths and simultaneously transfer some energy from the path to the body. The present invention is particularly, but not exclusively, useful for systems that relate to toy motion devices such as vehicles.

### BACKGROUND OF THE INVENTION

There are numerous designs of electromagnetic motion control systems executed as miniature toy railways that include a track and at least one vehicle located on said track.

There are known systems of this type, for example, U.S. Pat. No. 4,861,306 “Toy Cog Railway” and U.S. Pat. No. 6,648,724 “Toy Railway Liquid Transfer Facility”, that include the track (platform, chassis) driven by an engine and vehicle mounted on said track.

Another type of system, for example, U.S. Pat. No. 3,729,866 “Toy Railway Vehicle and Switching Section”, is comprised of a battery powered vehicle with an electric motor.

The most widely known electromagnetic moving system in the toy industry, as applied to miniature toy railway systems, includes a track comprised of at least two conductive bands that are connected to an electrical supply from which the electric motor of said vehicle can take power by means of brushes or sliding conductive contacts,—see, for example, U.S. Pat. No. 4,217,727 “Miniature Monorail System”.

The main problem of all such known systems is that it is difficult to generate reliable high speed motion of such vehicles because of the absence of attraction between the vehicle and the track, especially at higher speed on turns, and also when the track follows a vertical or nearly vertical path as in a vertical ring or spiral. Even when track sections are configured horizontally an object made to travel at high speed can lose stability and depart the track due to centrifugal and other forces. So, known electromagnetic moving systems must either be speed limited or include some special means to provide reliable attraction between the driven vehicle and the track or mechanical guide by the track. In some cases attraction is achieved between magnets on the bottom of the vehicle while the track is made of magnetic conductive (attractive) material. But these means in known systems also add resistance to motion, or drag, to the moving vehicle which therefore requires much more power to achieve motion. Most such toys use conductive brushes to provide electrical contact with the electric power source. Some toys use batteries that do not require brushes, in which case they operate uncontrolled, or achieve control through wires or via a wireless radio or infra-red connection, but in such cases have limited operating time due to battery life.

The problems mentioned above were overcome according to the published U.S. patent application Ser. No. 11/176,172 filed Jul. 7, 2005 by the same assignee.

Mentioned above inventions do not employ auxiliary energy consuming devices, for example a light source, placed on the vehicles for more entertainment, because of the lack of such energy.

According to the U.S. Pat. No. 3,513,338 “Vehicles with Linear Induction Motor” a moving body, driven along a linear induction motor, comprises a pickup winding to generate electric power useful for auxiliary purposes in the moving body. Electric power supplied to the system is converted to propulsion and auxiliary energy at the same frequency. But such energy conversion at one frequency is inefficient.

Therefore, it would be generally desirable to provide an energy converting system that overcomes problems associated with inefficient energy conversion in electromagnetic moving systems.

### SUMMARY OF THE INVENTION

According to the present invention, an energy converting system is comprised of a track, a controller, and at least one magnetized body located on said track and including an energy converting unit. The general idea of the claimed invention is that it employs an electromagnetic moving system with electric energy conversion to propulsion and auxiliary energy separated by the corresponding frequencies.

In order to achieve these objectives, according to the present invention, the track comprises electrically connected coil windings spaced apart in a series way along the track to form a multi-phase linear stator. The controller is electrically connected with the linear stator and generates a combination waveform consisting of a multi-phase propulsion signal plus a separate power signal. The stator is executed as at least a 3-phase multi-phase linear stator. The propulsion and power signals are distant by the corresponding frequencies of the signals. The propulsion signal causes the interaction of the magnetized body with the linear stator, thus propelling the magnetized body along the track. The energy converting unit comprises electrically connected energy consuming means and at least one pick-up coil inductively coupled to the linear stator, thus the power signal to be consumed by the energy consuming means.

The magnetized body placed upon the contact surface of the track is comprised of at least one magnetized object with its magnetic axis substantially perpendicular to the contact surface, thus causing interaction with the linear stator when it is powered, creating a force tending to propel the magnetized body along the track in the manner of a linear motor. The magnetized object may be made as at least one permanent magnet.

It is preferable that the frequency of the power signal will be higher than the frequency of the propulsion signal.

The energy converting unit may further comprise an energy storage means. There are two variants of the energy storage means. According to the first variant the energy storage means may be executed as at least one capacitor, and according to the second variant—as at least one cell of an electrochemical storage device.

The energy consuming means may be executed as a light source or an electro-mechanical motion device. The light source may be executed as a light emitting diode (LED) and the energy converting unit may further comprise a timer thus providing control of the LED. The electro-mechanical motion device may be executed as a solenoid moving flag or as a sound generator and the energy converting unit may further comprise a timer thus providing control of the sound generator.

According to the preferred embodiment, the controller comprises a programmable logic device that governs the power signal, thus the energy consuming means operates in accordance with code instructions loaded into the programmable logic device either previously or as part of the composite signal transmitted via the track coils.

The controller is comprised of a voltage regulator and/or a propulsion signal regulator to change the attraction of the magnetized body to the track by modulating voltage and therefore current, and/or speed of the magnetized body by modulating frequency correspondingly. The controller may include a phase sequence commutator thus causing the magnetized body to selectively move in opposite directions along the track.

The coil windings of the linear stator may be made as a printed circuit board or stamped upon a dielectric substrate. According to another variant, the coil windings are made as surface mounted coils spaced on a printed circuit board or on a stamped dielectric substrate.

To further increase the system efficiency the pick-up coil is electro-magnetically tuned to the frequency of said power signal.

The foregoing and other objectives, features and advantages of the invention will be more readily understood upon consideration of the following detailed description of the invention, taken in conjunction with the accompanying drawings.

### BRIEF DESCRIPTION OF THE DRAWINGS

FIG. 1 is a perspective view showing the preferred embodiment of the present invention.

FIG. 2 is a principal scheme describing the preferred embodiment of the present invention according to FIG. 1 (magnetized body not shown).

FIG. 3 is a principal scheme describing a variant of the energy converting unit when the light source is executed as the light emitting diode.

FIG. 3A is a principal scheme describing a variant of the energy converting unit with the timer and the energy storage means made as the capacitor.

FIG. 3B is a principal scheme describing a variant of the energy converting unit when the energy storage means made as at least one cell of an electrochemical storage device.

FIG. 3C is a principal scheme describing a variant of the energy converting unit has single wave rectification using two diodes as a voltage doubler.

FIG. 3D is a principal scheme describing a variant of the energy converting unit when the pick-up coil includes a ferrite core.

FIG. 4 is a principal scheme describing a variant of the energy converting unit when the electro-mechanical motion device is executed as the solenoid moving flag.

FIG. 5 is a principal scheme describing a variant of the energy converting unit when the electro-mechanical motion device is executed as the sound generator.

FIG. 6 is a perspective view showing a part of the multi-phase linear stator when the coil windings are made as a printed circuit board or stamped upon a dielectric substrate.

FIG. 6A is a perspective view showing a part of the multi-phase linear stator when the coil windings are made as surface mounted coils spaced on a printed circuit board or on a stamped dielectric substrate.

### DETAILED DESCRIPTION OF THE INVENTION

The present invention will be described in detail below with reference to the accompanying drawings.

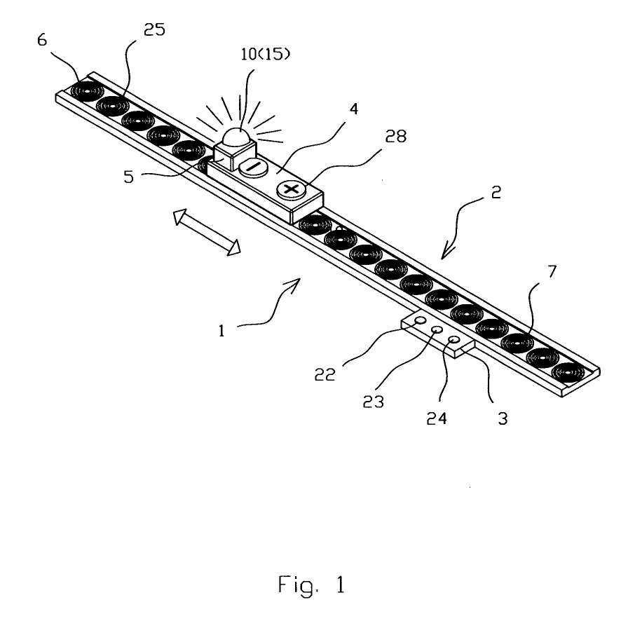

FIGS. 1-6A show embodiments of the present invention.

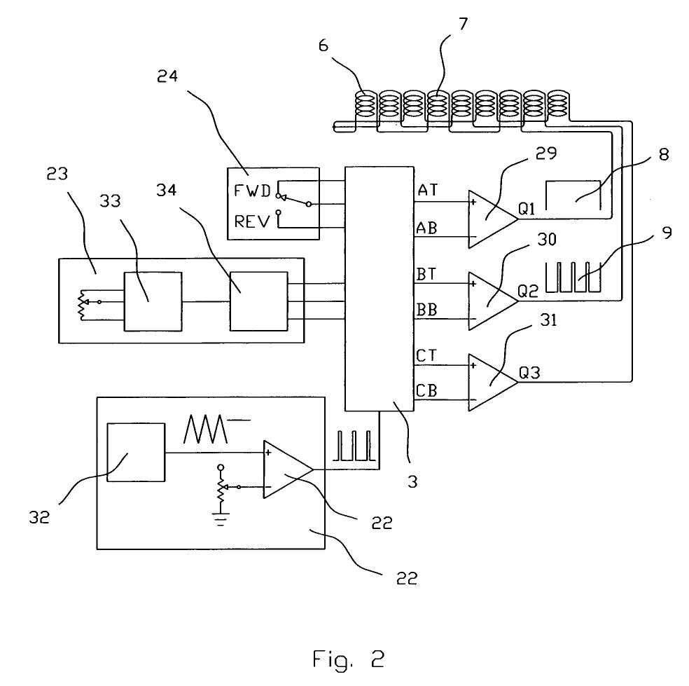

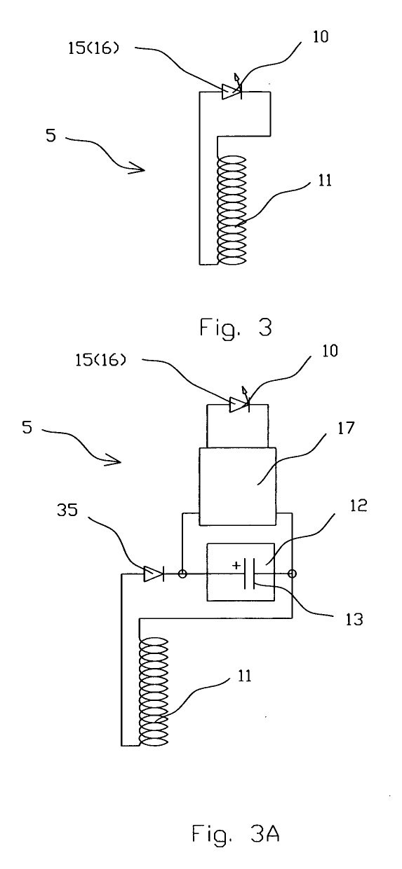

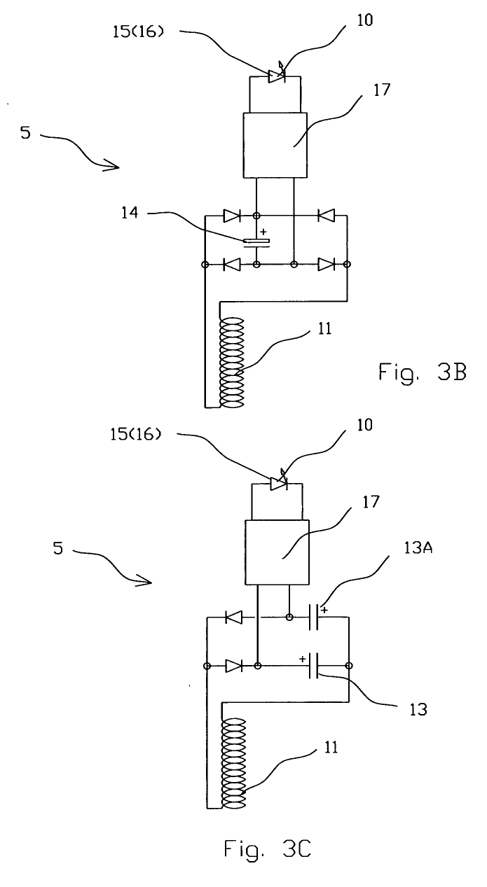

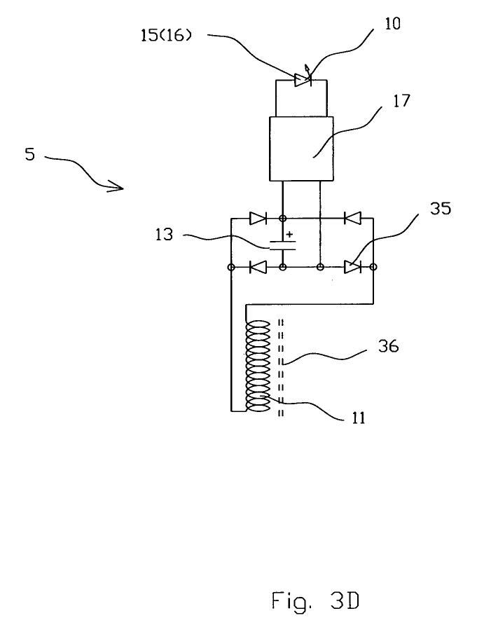

The energy converting system 1 according to the preferred embodiment (FIGS. 1-2) is comprised of a track 2, a controller 3, and at least one magnetized body 4 located on the track 2 and including an energy converting unit 5. The track 2 comprises electrically connected coil windings 6 spaced apart in a series way along the track 2 to form a multi-phase linear stator 7. The controller 3 is electrically connected with the linear stator 7 and generates a combination waveform consisting of a multi-phase propulsion signal 8 and a power signal 9. The stator 7 is executed as at least a 3-phase multi-phase linear stator. The propulsion and power signals 8 and 9 are distant by the corresponding frequencies of the signals. The propulsion signal 8 causes the interaction of the magnetized body 4 with the linear stator 7, thus propelling the magnetized body 4 along the track 2. The energy converting unit 5 comprises electrically connected energy consuming means 10 and at least one pick-up coil 11 (FIGS. 3-5) inductively coupled to the linear stator 7, thus the power signal 9 is available to be consumed by the energy consuming means 10.

The magnetized body 4 placed upon the contact surface of the track 2 is comprised of at least one magnetized object with its magnetic axis substantially perpendicular to the contact surface thus causing interaction with the linear stator 7 when it is powered, creating a force tending to propel the magnetized body 4 along the track 2 in the manner of a linear motor. The magnetized object may be made as at least one permanent magnet 28.

It is preferable that the frequency of the power signal 9 will be higher than the frequency of the propulsion signal 8.

The energy converting unit 5 may further comprise an energy storage means 12. There are two variants of the energy storage means 12. According to the first variant the energy storage means 12 may be executed as at least one capacitor 13, and according to the second variant—as at least one cell of an electrochemical storage device 14.

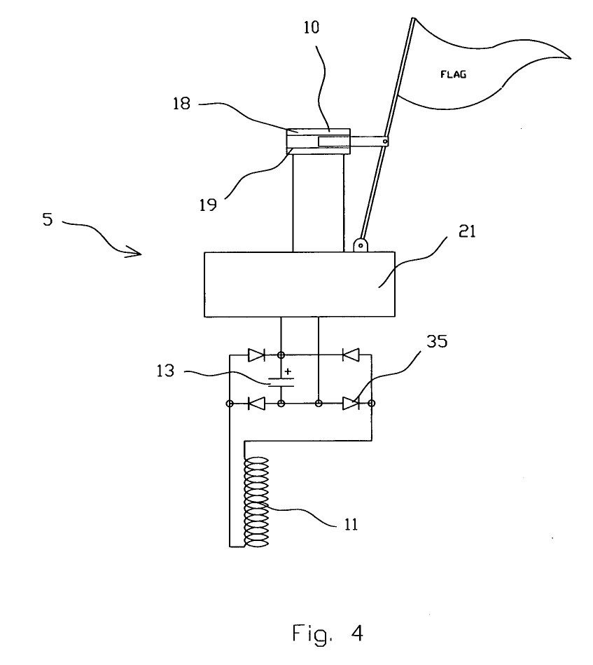

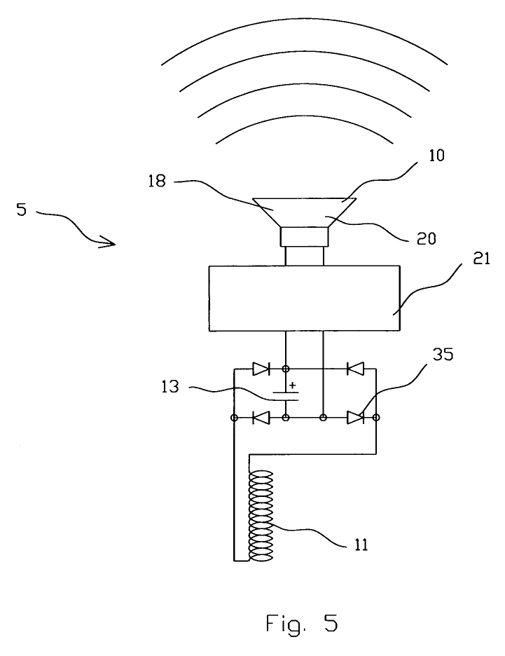

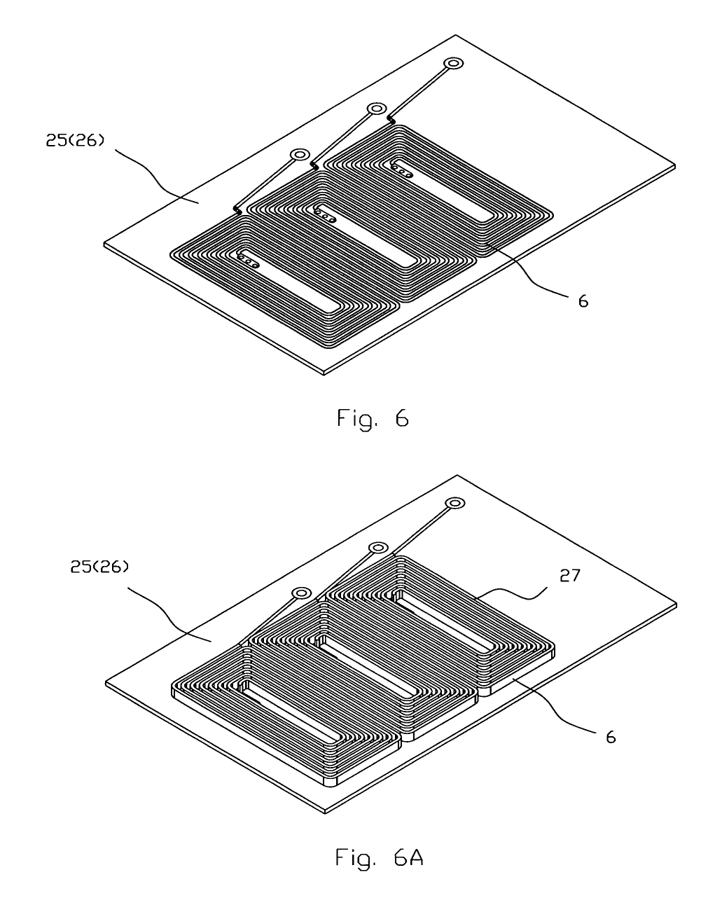

The energy consuming means 10 may be executed as a light source 15 (FIGS. 1, 3-3D) or an electro-mechanical motion device 18 (FIGS. 4 and 5). The light source 15 may be executed as a light emitting diode (LED) 16 and the energy converting unit may further comprise a timer 17 thus providing control of the LED 16. In one's turn, the electro-mechanical motion device 18 may be executed as a solenoid that moves flag 19 (FIG. 4) or as a sound generator 20 (FIG. 5) and the energy converting unit 5 may further comprise a timer 17 thus providing control of the sound generator 20.

According to the preferred embodiment, the controller 3 comprises a programmable logic device 21 (FIGS. 4 and 5) that governs the power signal 9, thus the energy consuming means 10 operates in accordance with code instructions loaded into the programmable logic device 21.

The controller 3 is comprised of a voltage regulator 22 and/or a propulsion signal regulator 23 (FIGS. 1 and 2) to change the attraction of the magnetized body 4 to the track 2 by modulating voltage and therefore current, and/or speed of the magnetized body 4 by modulating frequency correspondingly. The controller 3 may include a phase sequence commutator 24 thus causing the magnetized body 4 to selectively move in opposite directions (shown by arrow on FIG. 1) along the track 3.

The coil windings 6 of the linear stator 7 may be made as a printed circuit board 25 or stamped upon a dielectric substrate 26. According to another variant, the coil windings 6 are made as surface mounted coils 27 spaced on a printed circuit board 25 or on a stamped dielectric substrate 26.

To further increase the system efficiency the pick-up coil 11 may include the ferrite core 36 (FIG. 3D) and may be electro-magnetically tuned to the frequency of said power signal 9.

The energy converting system 1 operates as follows. When electrical power is supplied from the power source (not shown) to the coils windings 6 of the track 2 that operate together as the stator 7, alternating electromagnetic fields are created. First, the electrical power is supplied to two adjacent coils windings 6 of the linear stator 7 located on a part of the track 2 where the magnetized body 4 is located at the commencement of the process. The electromagnetic field created by two adjacent coils windings 6 interacts with a magnetic field created by the permanent magnets 28 of the magnetized object, which serve as the magnetized body 4. As a result, the magnetized body 4 is propelled along the track 2 to the next segment of coils 6 of the track 2 with two adjacent coils windings 6, where the polarity of electrical power is switched by the controller 3, further propelling the magnetized body 4, and the magnetized body 4 continues to move to subsequent coils windings 6, and so on.

The controllers 3 output uses frequency to control the speed the magnetized body 4 is propelled on the track 2. The higher the frequency the faster the magnetized body 4 travels. This may be augmented by adjusting the output voltage of the frequency wave. A lower voltage allows for a smoother and more efficient slow speed operation. At higher frequencies the voltage is increased to help maintain the magnetized body 4 lock with the track 2 drive. This allows the magnetized body 4 to travel faster and handle curves better.

The principal scheme in FIG. 2 is a functional block diagram of the 3-phase motor controller 3 employing a high frequency pulse width modulation (PWM) to control the drive current. This type of controller is known to any individual familiar in the art of motor control and particularly 3-Phase DC brushless motor control. The following description is how the controller 3 relates to a linear track drive and the unique properties it offers for the present invention. Current control allows for a more efficient track 2 operation where higher drive currents are only used when required as in moving the magnetized body 4 on curves or hills. This same high frequency PWM also allows a method of transformer coupling of this track 2 energy to the moving magnetized body 4 to power a variety of energy consuming means 10 it may contain as illustrated in FIGS. 3 through 5.

FIG. 2 has two oscillators 32 and 33 illustrated. Oscillator 32 operates at a fixed high frequency and is used to create the PWM to control overall track 2 voltage or drive current by means of the voltage regulator 22 control. The other oscillator 33 operates at a much lower frequency and is used to control the speed of the magnetized body 4 by mean of the propulsion signal regulator 23 control. This lower frequency oscillator 33, clocks a digital counter 34, and is decoded to supply the proper three phase input signal to the 3-phase controller 3. Here this signal is processed and modulated with the high frequency PWM to generate a three phase signal supplied to the drivers (Q1, Q2, and Q3). The 3-phase controller 3 also contains a method to changing the phase sequence commutator 24 to control the direction of the magnetized body 4 on the track 2 by means of the illustrated FWD/REV switch. The PWM can be combined in the 3-phase controller 3 to modulate the upper driver outputs (AT, BT, and CT) or the lower driver outputs (AB, BB, and CB). The preferred embodiment controllers modulate the lower drive outputs. Only two driver outputs are active at a given time. FIG. 1 illustrates driver Q1 is a continuous high state output while driver Q2 is the modulated low state output.

The moving magnetized body 4 has two ways of using the energy collected from the track 2 either directly or by storing the energy. Many different types of electrical devices may be powered from the stored energy including but not limited to those which generate sound, light and motion.

FIG. 3 shows one possible way of using the energy directly. Here the pick-up coil 11 sends the energy directly to a light emitting diode (LED) 16 which creates a moving object with illumination.

In FIG. 3A the pick-up coils 11 energy is rectified by a diode 35 and is stored in energy storage means made as a capacitor 13 or a cell of an electrochemical storage device 14 (FIG. 3B). The DC energy is then used to power a timer 17 which flashes a LED 16 (FIG. 3C).

Many methods of rectification are possible. FIGS. 3A-3C are examples of these methods. FIG. 3A has single wave rectification. FIG. 3B illustrates full wave bridge rectification. FIG. 3C has single wave rectification using two diodes 35 as a voltage doubler.

The energy pick-up coil 11 may have an air, ferrite or ferrous metal core 36 (FIG. 3D) depending on the modulated frequency used. FIG. 3D has the same circuit as FIG. 3B using the ferrite core 36.

Therefore, the claimed invention is employed the more efficient electromagnetic moving system with electric energy conversion to propulsion and auxiliary energy separated by the corresponding frequencies.

We claim:

1. An energy converting system comprising a track, a controller, and at least one magnetized body located on said track and including an energy converting unit, wherein:
(i) said track comprises electrically connected coil windings spaced apart in a series way along said track to form a multi-phase linear stator;
(ii) said controller is electrically connected with said linear stator and generates a combination waveform consisting of a multi-phase propulsion signal and an auxiliary power signal;
(iii) said propulsion and power signals are distant by the corresponding frequencies of said signals;
(iv) said propulsion signal causes the interaction of said magnetized body with said linear stator, thus propelling said magnetized body along said track;
(v) said energy converting unit comprises electrically connected energy consuming means and at least one pick-up coil inductively coupled to said linear stator, thus said power signal to be consumed by said energy consuming means.

2. The system as claimed in claim 1, wherein the frequency of said power signal is higher than the frequency of said propulsion signal.

3. The system as claimed in claim 1, wherein said energy converting unit further comprises an energy storage means.

4. The system as claimed in claim 3, wherein said energy storage means is executed as at least one capacitor.

5. The system as claimed in claim 3, wherein said energy storage means is executed as at least one cell of an electrochemical storage device.

6. The system as claimed in claim 1, wherein said energy consuming means is executed as a light source.

7. The system as claimed in claim 6, wherein said light source is executed as a light emitting diode.

8. The system as claimed in claim 7, wherein said energy converting unit further comprises a timer thus providing control of said light emitting diode.

9. The system as claimed in claim 1, wherein said energy consuming means is executed as an electro-mechanical motion device.

10. The system as claimed in claim 9, wherein said electro-mechanical motion device is executed as a solenoid moving flag.

11. The system as claimed in claim 9, wherein said electro-mechanical motion device is executed as a sound generator.

12. The system as claimed in claim 11, wherein said energy converting unit further comprises a timer thus providing control of said sound generator.

13. The system as claimed in claim 1, wherein said controller comprises a programmable logic device that governs said power signal, thus said energy consuming means operate in accordance with code instructions previously loaded into said programmable logic device.

14. The system as claimed in claim 1, wherein said controller comprises a voltage regulator and/or a propulsion signal regulator to change the attraction of said magnetized body to said track and/or speed of said magnetized body correspondingly.

15. The system as claimed in claim 1, wherein said controller comprises a phase sequence commutator thus enabling said magnetized body to change the moving direction.

16. The system as claimed in claim 1, wherein said linear stator is executed as at least a 3 phase linear stator.

17. The system as claimed in claim 1, wherein said coil windings of said linear stator are made as a printed circuit board or stamped upon a dielectric substrate.

18. The system as claimed in claim 1, wherein said coil windings are made as surface mounted coils spaced on a printed circuit board or on a stamped dielectric substrate.

19. The system as claimed in claim 1, wherein said magnetized body comprises of at least one permanent magnet.

20. The system as claimed in claim 1, wherein said pick-up coil is electro-magnetically tuned to the frequency of said power signal.
